(19) United States
(12) Patent Application Publication
(10) Pub. No.: US 2023/0004261 A1
(43) Pub. Date: Jan. 5, 2023

(54) DATA PROCESSING METHOD, TERMINAL DEVICE AND SERVER DEVICE

(71) Applicant: Jian Sun, Yancheng, Jiangsu (CN)

(72) Inventor: Jian Sun, Yancheng, Jiangsu (CN)

(21) Appl. No.: 17/778,594

(22) PCT Filed: Oct. 25, 2020
(86) PCT No.: PCT/CN2020/123483

§ 371 Date: May 20, 2022

(30) Foreign Application Priority Data
Nov. 21, 2019 (CN) 201911150399.0

(51) Int. Cl. G06F 3/0482; G06F 3/14; H04M 1/7243

(52) U.S. Cl. CPC G06F 3/0482; G06F 3/14; H04M 1/7243

(57) ABSTRACT

The present invention discloses a data processing method, a terminal device and a server device. The method comprises steps of acquiring messages and adding and displaying list items of the messages in an electronic content list. With the method of the present disclosure, list items of messages can be provided in an electronic content list so as to provide a new operating mode for reading the messages.

### TECHNICAL FIELD

The present disclosure relates to the technical field of Internet and more particularly relates to a data processing method, a terminal device, a server device and a computer readable storage medium for instant messages.

### BACKGROUND

Instant communication is the most popular communication mode at present, and people can use an instant communication application to send instant messages to contacts in the address book of the application.

Meanwhile, people are used to learning about the world through electronic content applications. Electronic contents are the contents stored or disseminated in the form of data, and can be news, product introduction, or articles in a professional field. Electronic content applications are client software used for providing electronic contents, and can be specially developed client software such as Yahoo News, Toutiao and Douyin or browsers for visiting electronic content websites such as a universal browser for visiting the Yahoo News website.

At present, electronic content display and instant communication are two independent functions and have no relationship. If a user wants to know whether a new instant message exists or to view the content thereof when reading electronic contents provided by an electronic content application on a terminal device such as a mobile phone, the user needs to switch to an instant communication interface, for example, returning to the desktop first and then clicking on the instant communication application, to enter the instant communication dialog interface to view the instant message. In addition, if the user wants to continue to read the electronic contents after viewing the instant message, multiple steps are required to return to the electronic content application to continue to read the electronic contents. Such switching operation obviously suspends the user from reading the electronic contents and affects the user experience.

### SUMMARY

One purpose of embodiments of the present disclosure is to provide a new technical solution for data processing of instant messages.

According to the first aspect of the present invention, a data processing method is provided, comprising:

Acquiring messages;

Adding and displaying list items of the messages in an electronic content list.

According to the second aspect of the present invention, a terminal device is also provided, comprising:

A memory, used for storing executable instructions;

A processor, used for executing the instructions to implement the method according to the first aspect of the present invention.

According to the third aspect of the present invention, a computer readable storage medium is also provided, storing computer program instructions, wherein the computer program instructions are used for implementing the method according to the first aspect of the present invention when being read and run by the computer.

According to the fourth aspect of the present invention, a server device is also provided, comprising a memory, used for storing computer program instructions for implementing the method according to the first aspect of the present invention for downloading.

According to the fifth aspect of the present invention, a data process system is also provided, comprising a server and the terminal device according to the second aspect of the present invention, wherein the server is used for providing messages, and the terminal device is used for acquiring the messages from the server.

The embodiments of the present disclosure have one beneficial effect that: the data processing method of the embodiments can add and display list items of messages such as instant messages in an electronic content list, so the list items of messages can be provided in the electronic content list by the method of the embodiments, and in this way, when the user views the electronic contents, if a new message is received, a list item of the new message will be added and naturally embedded in the electronic content list, which not only alerts the user to the new message in a timely manner, but also allows the user to read the message after reading the current electronic contents or to easily decide to continue reading the electronic contents or reply immediately or after thinking according to the content of the message, thus reducing disturbance to the reading of the user. Therefore, the data processing method according to the embodiments improves the user experience and is conducive to improving the user viscosity for electronic content applications.

Other features and advantages of the present disclosure will become clear by the following detailed description of the exemplary embodiments of the present disclosure with reference to the drawings.

### DESCRIPTION OF DRAWINGS

The drawings incorporated into the description and constituting part of the description show the embodiments of the present disclosure and are used to explain the principle of the present disclosure together with the description.

FIG. 1 is a schematic block diagram of a data processing system implementing a data processing method of the embodiments of the present disclosure;

FIG. 2 is a flow diagram of a data processing method according to embodiment 1 of the present disclosure;

FIG. 3 is a schematic diagram of an electronic content list interface of embodiment 1 of the present disclosure;

FIG. 4 is a schematic diagram of an electronic content detail interface displayed after the list items of electronic contents shown in FIG. 3 are opened;

FIG. 5 is a schematic diagram of a list interface presented after list items of instant messages are added to an electronic content list according to embodiment 1 of the present disclosure;

FIG. 6 is a schematic diagram of a corresponding instant communication dialog interface presented after the list items of instant messages shown in FIG. 5 are opened;

FIG. 7 is a schematic diagram of a changed detail interface after the target application receives a new message when a user reads an electronic content detail interface shown in FIG. 4;

FIG. 8 is a schematic diagram of a message list interface opened to view messages on the detail interface shown in FIG. 7;

FIG. 9 is an interface diagram of adding an operation interface for replying to messages to list items of messages according to embodiment 9 of the present disclosure;

FIG. 10 is an interface diagram of displaying list items of multiple types of messages in an electronic content list according to embodiment 11 of the present disclosure;

FIG. 11 is a schematic diagram of a setting interface for setting display conditions of messages according to embodiment 12 of the present disclosure;

FIG. 12a and FIG. 12b are schematic diagrams of a drop-down list of a setting interface shown in FIG. 11;

FIG. 13 is a data exchange flow diagram of a data processing system according to one example of the present disclosure;

FIG. 14 is a processing flow diagram of providing instant messages for a target application by an instant message server of a first application according to one example of the present disclosure;

FIG. 15 is a processing flow diagram of providing instant messages for a client of a target application by a client of a first application according to one example of the present disclosure;

FIG. 16 is a flow diagram of processing SMS messages by a client of a target application according to one example of the present disclosure;

FIG. 17 is a flow diagram of processing acquired instant messages by a target application according to one example of the present disclosure;

FIG. 18 is a flow diagram of processing instant messages containing shared contents by a target application according to one example of the present disclosure;

FIG. 19 is a flow diagram of screening messages to be displayed by a client of a target application in accordance with the set display conditions according to one example of the present disclosure;

FIG. 20 is a processing flow diagram of triggering for receiving the click on list items of messages according to one example of the present disclosure.

### DETAILED DESCRIPTION

Various exemplary embodiments of the present disclosure are described in detail with reference to the drawings. It should be noted that unless specifically stated otherwise, the relative arrangement, numerical expressions and numerical values of components and steps stated in the embodiments do not limit the scope of the present disclosure.

The following description of at least one exemplary embodiment is actually only illustrative, and shall not be intended to limit the present disclosure and its application or use.

The technologies, methods and devices known to those ordinary skilled in the relevant arts may not be discussed in detail, but the technologies, methods and devices should be regarded as part of the description as appropriate.

In all examples shown and discussed herein, any specific value should be interpreted as merely exemplary, not restrictive. Therefore, other examples of exemplary embodiments may have different values.

It should be noted that similar reference signs and letters indicate similar items in the following drawings. Therefore, a certain item will not be further discussed in the subsequent drawings once defined in one drawing. Some specific electronic contents or message contents in each interface are not related to the method of the present disclosure and thus are replaced by an ellipsis.

<Hardware Structure>

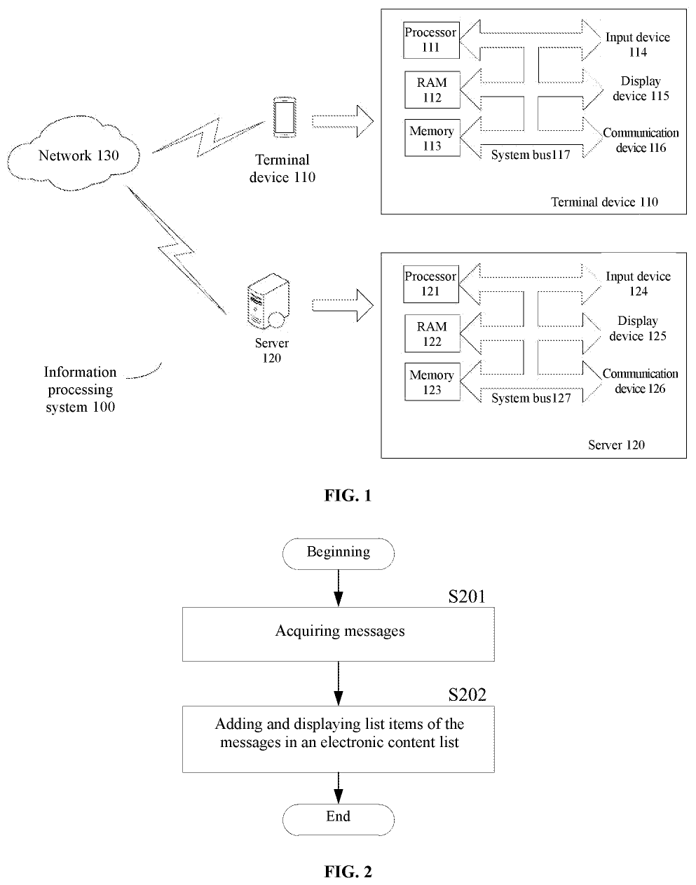

FIG. 1 is a structural schematic diagram of hardware composition of a data processing system used for implementing a data processing method according to the embodiments of the present disclosure.

As shown in FIG. 1, the data processing system 100 of the embodiment at least comprises a terminal device 110 and a server 120. A communication connection is established between the server 120 and the terminal device 110 through a network 130 for data exchange, for example, the terminal device 110 can acquire message data from the server 120.

The terminal device 110 can be a smart phone, a portable computer, a desktop computer and a tablet computer.

As shown in FIG. 1, the terminal device 110 can comprise a processor 111, an RAM (random access memory) 112, a memory 113, an input device 114, a display device 115 and a communication device 116 which are connected through a bus 117.

The server 120, for example, can be a blade server and a rack-mount server, and the server 120 can also be a server cluster deployed in the cloud.

As shown in FIG. 1, the server 120 can comprise a processor 121, an RAM 122, a memory 123, an input device 124, a display device 125 and a communication device 126 which are connected through a bus 127.

The processors 111 and 121 are used for executing program instructions. The program instructions can be an instruction set of architectures such as x86, Arm, RISC, MIPS and SSE.

The memories 113 and 123 are used for storing program instructions, and can be readable storage media such as solid state disk, magnetic hard disk, optical disc, flash disk and ROM (read-only memory) capable of storing data after power failure.

The input devices 114 and 124, for example, can comprise a touch screen, a keyboard and a mouse. A user can issue instructions to the terminal device 110 or the server 120 through operation performed on the input devices.

The display devices 115 and 125 can comprise a graphic controller and a display connected to the graphic controller, and the display can be an LCD display, an LED display, a CRT display or a touch screen.

The communication devices 116 and 126 comprise, for example, an RJ45 module, a WIFI module, a 2G-6G mobile communication module, or a network adapter of a Bluetooth module. The terminal device 110 and the server 120 are connected to the network in a wired or wireless mode and communicated with each other on the network.

The network 130 in FIG. 1 is used to enable data transmission between the terminal device 110 and the server 120 which are connected to the network. The network 130 can be a local area network or the Internet, and adopt protocols such as HTTP, TCP/IP and WIFI during transmission. Devices on the network comprise copper transmission cables, optical fiber transmission, wireless transmission, routers, firewall, switches and gateway computers.

In the embodiments of the present disclosure, the processor 111 of the terminal device 110 loads program instructions from the memory 113 into the RAM 112 and executes the instructions to implement the data processing method of the present disclosure. The terminal device 110 can adopt an operating system such as Android, iOS and Windows.

In the embodiments of the present disclosure, the processor 121 of the server 120 loads program instructions from the memory 123 into the RAM 122 and executes the instructions to implement or support the implementation of the data processing method of the present disclosure. The server can adopt an operating system such as Linux and Windows.

Technical personnel can design the above instructions according to the solution disclosed in the description. How the instructions control the processor to perform operations is well known in the art and thus is not described in detail here.

The data processing system 100 shown in FIG. 1 is only explanatory, but not used for limiting the description and its application or use. For example, FIG. 1 only shows one terminal device 110 and one server 120, which is not intended to limit the respective number, and the data processing system 130 can comprise a plurality of servers and/or a plurality of terminal devices.

Different servers can process different types of service requests, as determined by server programs installed in the servers, for example, electronic content server programs capable of processing requests such as electronic content delivery and subscription, or message server programs capable of processing message receiving and sending, such as server programs for instant communication. In the present disclosure, the same server program can be distributed in a plurality of specific server computer devices, which are regarded as one server. For example, a message server may have more than one server computer device. Two service programs with different functions, such as server programs processing electronic contents and processing messages, may also be located in one server computer device. The two service programs are regarded as different servers due to implementing different functions.

### Method Embodiment

The “message” in the embodiments of the present disclosure means a message transmitted to a specific user by a sender based on the message transmission function provided by a message application, wherein the specific user is a receiver. For the receiver, the message may be important or require a prompt reply. The message involved in the embodiments of the present disclosure, for example, is an instant message sent through an instant communication application, an Email message sent through an Email application, or an SMS message sent through a mobile communication system.

The data processing method of the embodiments of the present disclosure can be implemented by a terminal device such as a target application installed in the terminal device 110 in FIG. 1. The target application is an application adopting the method in the present disclosure and can display at least an electronic content list.

In addition, the target application can have the message transmission function such as instant communication function, i.e., the target application has a dedicated message server such as the server 120 in FIG. 1 so that the target application can serve as a message application. The target application may also not have the message transmission function but can acquire messages from other message applications. In the following embodiments, the user name of the user of the terminal device in the target application is “UserA”.

FIG. 2 is a flow diagram of a data processing method according to embodiment 1 of the present disclosure. As shown in FIG. 2, the data processing method of the embodiment can comprise the following step S201 and step S202.

Step S201: acquiring messages through a target application.

The target application can acquire message data from a message server of the target application, for example, the server 120 in FIG. 1, which is a frequently-used method.

The target application can also acquire the messages from a first application.

The first application is another message application installed in the terminal device where the target application is located, the user name of the user in the first application is UserA1, and the database of the server of the first application can have a record indicating that the user UserA1 has an associated user UserA in the target application.

The formation of the associated user is as follows: when registering the first application, the user firstly enters the user name UserA in the target application and then enters the user name UserA1 in the first application so as to form association. Also, the user can firstly register in the first application with the user name UserA1 and then set the user UserA in the target application as the associated user. The user names UserA and UserA1 represent actual users of the terminal device and thus can be collectively called the local user of the terminal device.

The target application can acquire the messages from the client of the first application.

The messages of the first application can be Wechart messages, NetEasy Email messages or SMS messages.

Step S202: adding and displaying list items of the messages in an electronic content list.

The electronic content list of the target application contains multiple list items of electronic contents. After the target application acquires the messages, the list items of the messages can be added and displayed in the electronic content list of the target application, for example, list items of instant messages are added and displayed, so that the electronic content list can also contain the list items of the messages. Therefore, the user can view the list items of the messages directly or by sliding the electronic content list.

In the embodiment, the list items of the messages can display all or part of message contents of the messages, for example, summary contents extracted from the messages, or contents of the set number of words or lines of the messages. In actual use, due to the limit of the screen size of the terminal device, the terminal device can display only part of the list items in the electronic content list at any moment, so the list items of the messages can be further added and displayed in the current display area of the electronic content list. The current display area is an area where the user can view the list through the terminal device at the current moment. In this way, the user can immediately view the list item of the latest message in the current area of the electronic content list interface, and can receive the latest message without the need of pulling up or down the list for search.

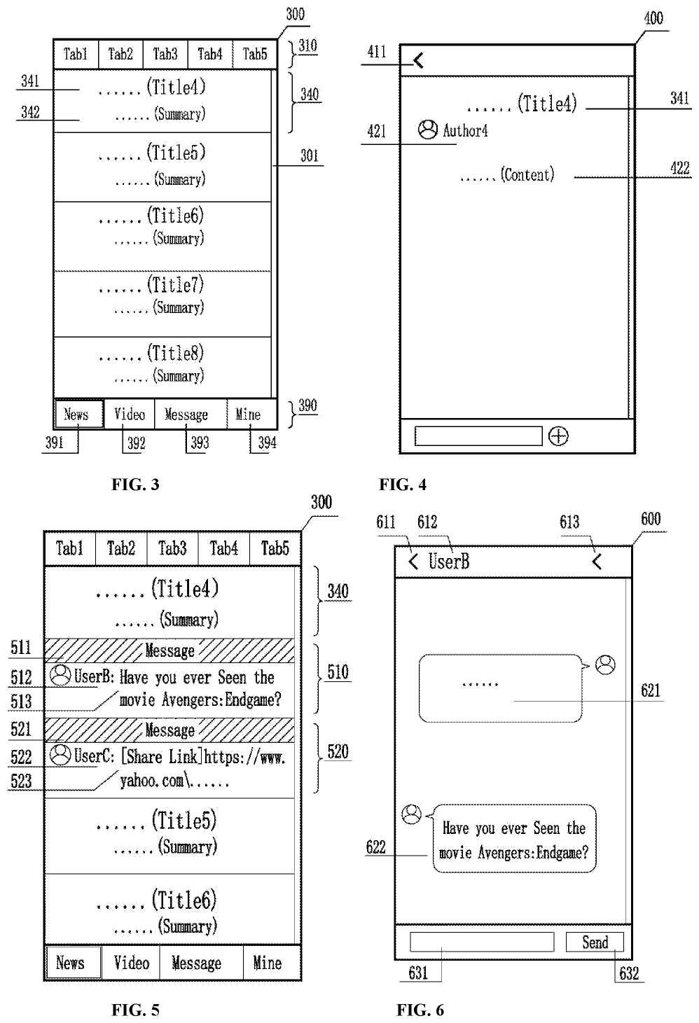

FIG. 3 shows an electronic content list interface 300. As shown in FIG. 3, the top of the electronic content list interface 300 is a tab bar area 310, comprising Tab1 to Tab5. The bottom area comprises a “News” option 391, a “Video” option 392, a “Message” option 393, and a “Mine” option 394. For example, the user can enter an instant message list by clicking on the “Message” option 393, wherein the instant message in the list items can come from the target application or other applications such as the first application.

As shown in FIG. 3, the middle area is the current display area of the electronic content list and comprises five list items. In the uppermost list item 340, an item 341 indicates the title information (“Title4”) of electronic contents, and an item 342 indicates the summary information (“Summary”) of the electronic contents. The following four list items of electronic contents have the title information of “Title5” to “Title8”. The rightmost item 301 in the middle area is a slider, indicating that the area to the left can slide up and down.

When the user clicks on any list item such as the item 340, the terminal device can open the corresponding electronic content detail interface 400 shown in FIG. 4 in response to the operation of opening the list item 340, and the detail interface 400 not only displays the title information (“Title4”) item 341 of the electronic contents, but also displays the author information (“Author”) item 421 and the text information (“Content”) item 422 of the electronic contents. An item 411 at the upper left corner is used for returning to the electronic content list interface 300 shown in FIG. 3.

When the terminal device displays the electronic content list interface 300 shown in FIG. 3, if the target application acquires a new message through step S201, the target application will add the list item of the new message in the current display area of the electronic content list according to the operation of step S202, and the changed list interface is shown in FIG. 5.

Alternatively, when the terminal device displays the electronic content detail interface 400 shown in FIG. 4, if the target application acquires a new message through step S201, when the user reads the contents on the detail interface and returns to the electronic content list interface 300, the client of the target application detects the new message and thus adds the list item of the new message when displaying the electronic content list, as shown in FIG. 5.

For example, the acquired new message is an instant message, and as shown in FIG. 5, the target application adds two list items of instant messages: a list item 510 and a list item 520, for example, below the list item 340 of electronic contents read in the current display area, wherein the list items of instant messages, for example, can comprise message marking areas 511 and 521 and message areas below. The list items are marked as list items of instant messages by displaying “Message” in the message marking areas 511 and 521 so that the list items of instant message can be displayed in a notable mode different from the list items of electronic contents. An item 512 in the message area is the sender UserB of instant messages, and a message content item 513 is “Have you ever seen the movie Avengers: Endgame?”. Also, for example, an item 522 in the message content area of the list item 520 displays the sender of instant messages as UserC, and a message content item 523 is a share link of Yahoo website.

In FIG. 5, the list items 510 and 520 of instant messages respectively have dedicated message marking areas 511 and 521 where “Message” is written, and the background color can be deeper. The measures are designed to display list items of instant messages in a notable mode to highlight the differences from list items of electronic contents and to alert the user to new instant messages in a more notable mode so that the user will not miss out on important messages.

For other types of messages acquired, the list items can be displayed in the same notable mode as the list items of instant messages or in different notable modes so that the user can also distinguish different types of messages through the message marking areas. For example, different colors are used in the message marking areas, or different message sources are indicated, so as to distinguish instant communication messages, Email messages, SMS messages, etc. sent from different applications.

According to the above steps S201-S202, the data processing method of the embodiment is used in the electronic content list. If a new message is received, the list item of the new message will be inserted and naturally embedded in the electronic content list, which maintains the integrity of the reading interface, not only alerts the user to the new message in a timely manner, but also reduces disturbance to the reading of the user. The user can read the message after reading the current electronic contents, or easily decide to continue reading the electronic contents or reply immediately or after thinking according to the content of the message after a quick glance at the message. Even if a new message is received and the list item cannot be displayed when the user reads electronic content details, after the user reads the electronic content details and then returns to the electronic content list, the new message can be quickly discovered.

In addition, the method of the embodiment has obvious advantages compared with the solution that the terminal device displays a corresponding prompt bar when a new instant message is received in the prior art. The prompt bar not only destroys the integrity of the electronic content interface and has smaller font size which is inconvenient for reading, but also appears on the screen for a short time, and if the user does not read the content of the prompt bar immediately, the prompt bar may disappear, so the user is forced to immediately stop reading the current electronic contents, which disturbs the normal reading of the user. Moreover, even if the user reads the content of the prompt bar immediately, the prompt bar may disappear before the user has time to think. Once the prompt bar is missed out, the user may need to return to the desktop first and then click on the instant communication application to enter the instant communication dialog interface to view the new message, which has many drawbacks. With the data processing method of the embodiment, the user will neither stop the current reading because of worrying about the disappearance of the prompt bar nor need to switch to the instant message interface to view the message through cumbersome steps after the disappearance of the prompt bar, which improves the user experience.

In embodiment 2, the data processing method can also comprise the following step after the above step S202, for example, when the user clicks on the list item 520 of the instant message shown in FIG. 5: opening an interface corresponding to the messages in response to the operation of opening the list item of the message.

The interface corresponding to the message is an interface completely displaying the corresponding message provided by the message application. For example, if the message is an instant message, the interface corresponding to the message is an instant communication dialog interface.

For example, when the user of the terminal device clicks on the list item 510 of the instant message on the list interface shown in FIG. 5, the target application will open the instant communication dialog interface 600 corresponding to the instant message shown in FIG. 6, that is to open the instant communication dialog interface 600 between the receiver of the instant message and the sender UserB of the instant message. In this way, the user can communicate instantly with the sender UserB through the instant communication dialog interface. As mentioned above, the instant communication dialog interface 600 may belong to the target application or first application.

The instant communication dialog interface 600 comprises an item 611, an item 612 and an item 613, wherein the text of the item 612 is used for displaying the name UserB of the other party of a dialog, the button of the item 611 is used for returning to the instant message list interface corresponding to the instant communication application, and the button of the item 613 is used for returning to the previous electronic content interface. For example, in the case of entering the instant communication dialog interface 600 shown in FIG. 6 through the electronic content list interface shown in FIG. 5, the user can return to the electronic content list interface shown in FIG. 5 through the item 613. In the following dialog display area, an item 621 is a message sent by the local user, and an item 622 is a message sent by the other party and has the same contents as the item 510 shown in FIG. 5.

According to the embodiment, the local user can not only view the content of the message through the list item of the message in the electronic content list, but also directly enter the interface corresponding to the message by opening the list item. In this way, the user can conduct a dialog, answer questions and express opinions through the interface corresponding to the message. Moreover, the user can directly return to the electronic content interface shown in FIG. 5 by clicking on the item 613 in FIG. 6.

In embodiment 3, when the local user clicks on the list item 520 of the instant message shown in FIG. 5, the data processing method can also comprise the following step after the above step S202: displaying shared contents in the case that the instant message contains the shared contents in response to the operation of opening the list item of the instant message.

According to the embodiment, in the case that the instant message contains shared contents, the user can directly open the shared contents by opening the list item of the instant message without the need of opening the instant communication dialog interface corresponding to the instant message first and then loading and displaying the shared contents by clicking on the link of the shared contents on the instant communication dialog interface.

In embodiment 4, further, the above step of displaying the shared contents can comprise: loading the shared contents according to the identifier of the shared contents specifically in at least one of the following methods:

The first method: in the case that the identifier is a website, opening the website to display the corresponding shared contents.

With FIG. 5 as an example, the item 523 in the list item 520 of the instant message in FIG. 5 contains shared contents, and the identifier “http://www.yahoo.com\ . . . ” of the shared contents is a website. Therefore, when the user opens the list item 520 of the instant message on the list interface shown in FIG. 5, the website can be opened to display the corresponding shared contents.

The second method: in the case that the identifier contains an application identifier, requesting the corresponding application to display the shared contents.

In the case that the application identifier is a target application, the target application can be directly requested to display the shared contents.

In the case that the application identifier is another application, if the terminal device is provided with the application, the application is opened and requested to display the shared contents.

In the case that the application identifier is another application, if the terminal device is not provided with the application, the application is installed first, then opened and requested to display the shared contents.

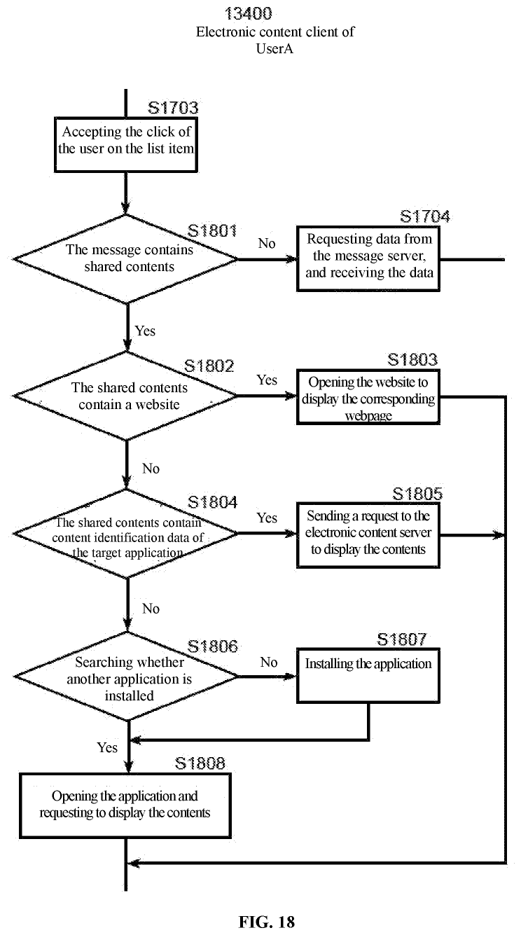

For the above specific process, the user can also refer to the description of FIG. 18 at the end of the description.

According to the method of the embodiment, the display of shared contents from different sources can be processed according to the identifier of shared contents.

In embodiment 5, when the user reads the electronic content detail interface 400 shown in FIG. 4, the terminal device acquires a new message. The data processing method can also comprise the following step: after acquiring the new message, displaying a prompt for the arrival of a new message on the electronic content detail interface.

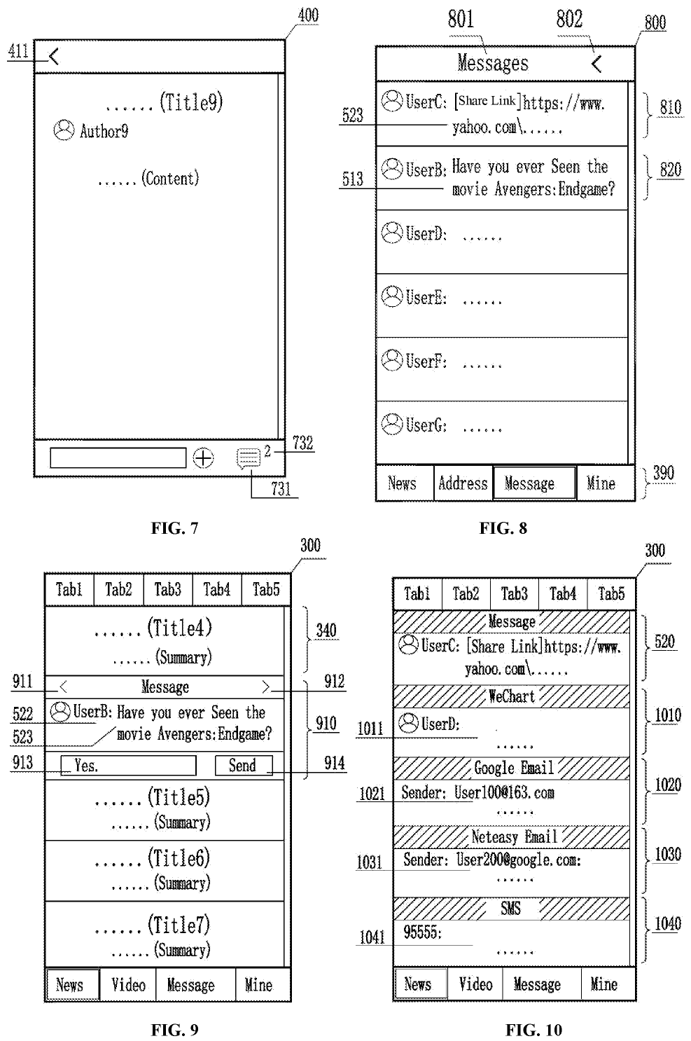

At this moment, the change of the electronic content detail interface 400 is shown in FIG. 7, wherein an item 731 indicates a new message; and an item 732 indicates the number of new messages which can be messages acquired when the detail interface 400 is opened or messages acquired before entering the detail interface 400 and not read by the local user. It can be seen that the prompt is a small icon embedded in the detail interface 400, which will not disturb the reading of the user.

In the detail interface 400 shown in FIG. 7, when directly clicking on the return icon item 411, the user can return to the list interface 300 shown in FIG. 5, which contains list items 510 and 520 of a new message. Therefore, the user can view the specific contents of the new message by only returning to the electronic content list interface 300.

In embodiment 6, further, when the user clicks on the item 731 in FIG. 7, the data processing method can also comprise: opening an interface corresponding to the message in response to the operation triggered on the detail interface for viewing the message, for example, as shown in FIG. 6, opening the instant communication dialog interface 600 corresponding to the instant message. If multiple messages are received, the user can open the interface corresponding to the latest message or the earliest unread message.

Further, if the instant message contains shared contents, the shared contents can be directly displayed according to the method of embodiment 4.

According to the method of the embodiment, the user can directly open the interface corresponding to the message or the interface of share contents on the electronic content detail interface without the need of returning to the electronic content list interface or switching to the message application to implement the operation, which is convenient for the user.

In embodiment 7, on the basis of embodiment 6, the interface corresponding to the message also comprises a message list interface. When the user clicks on the item 731 in FIG. 7, the data processing method can also comprise: acquiring the number of senders of new messages in response to the operation triggered on the detail interface for viewing the message; in the case of only one sender, opening the interface corresponding to the message, for example, opening the communication dialog interface 600 shown in FIG. 6, or directly opening the interface of shared contents according to the method of embodiment 4; and in the case that the number of senders is more than or equal to two, opening the message list interface, for example, opening a message list interface 800 shown in FIG. 8.

When the user clicks on the icon of the item 731 in FIG. 7, it can be seen from the item 732 that the number of new messages is two. When the client of the target application judges that the number of senders of new messages is more than one, the message list interface 800 shown in FIG. 8 is displayed, wherein an item 801 is the title “Messages” of the interface. List items 810 and 820 of new messages are listed first, respectively corresponding to messages of list items 520 and 510 in FIG. 5. The messages corresponding to the list items in FIG. 8 may come from the target application or from other applications such as the first application. The user can click the list item of the message to be replied, and the client can open the interface corresponding to the message according to the method of embodiment 2, or open the shared contents corresponding to the list items according to the method of embodiment 3 or embodiment 4.

In another embodiment, only list items of messages acquired when the detail interface is opened can be displayed in FIG. 8.

On the message list interface 800 shown in FIG. 8, an operation interface 802 for triggering a return instruction can be configured so that the user can return to the previous electronic content interface through the operation interface 802, for example, returning to the electronic content detail interface 400 shown in FIG. 7.

In embodiment 8, the data processing method can also comprise the following steps: configuring an operation interface for triggering a return instruction on the interface corresponding to the message; and returning to an electronic content interface before entering the interface corresponding to the message in response to a return instruction triggered through the operation interface.

With an instant message as an example, configuring an operation interface for triggering a return instruction on an opened instant communication dialog interface; and returning to an electronic content interface before entering the instant communication dialog interface in response to a return instruction triggered through the operation interface.

For example, in the aforementioned embodiments, the local user enters the instant communication dialog interface 600 shown in FIG. 6 by clicking on the list item 510 in FIG. 5. The local user can return to the interface in FIG. 5 by clicking on the return item 613 in FIG. 6. Alternatively, the user can enter the instant communication dialog interface 600 shown in FIG. 6 by clicking on the item 731 in FIG. 7. The local user can return to the interface shown in FIG. 7 by clicking on the return item 613 in FIG. 6, which is convenient for the user to continue to read the electronic contents from the stopping position after processing the new message.

The return item 611 in FIG. 6 is used for returning the message list interface corresponding to the message application. For example, if FIG. 6 shows the instant communication interface from the target application, the user can return to the message list interface of the target application by clicking on the return item 611, for example, the interface 800 shown in FIG. 8. For example, if FIG. 6 shows an instant communication interface from the first application, the users can return to the message list interface of the first application by clicking on the return item 611. The new return item 613, as mentioned above, can be used for returning to the previous electronic content interface. The user can clearly select the interface to return to by combining the above two conditions, which simplifies the operation of the user for returning to the electronic content interface.

In embodiment 9, the data processing method can also comprise the following step: displaying an operation interface for replying to messages in the list items of the messages.

FIG. 9 show an electronic content list interface 300, a list item 910 of a message is added in the electronic content list, and the list item 910 shows an input operation interface 913, i.e., an input box. The user enters “Yes” to reply to the instant message 523 of the user UserB. Then the user clicks on an adjacent sending operation interface 914, i.e., “Send” button, to trigger a sending instruction. In this way, the user can give a quick reply without entering the dialog interface corresponding to the message 523.

According to the embodiment, the user can reply to the message directly through an operation interface for replying to messages provided by the list items of a message in the electronic content list interface without the need of opening the interface corresponding to the message to reply to the message, thus making the reply of the user more convenient.

In embodiment 10, a message switching operation interface is configured in the list items of a message. The embodiment shown in FIG. 5 has two list items of an instant message. When the number of list items of an instant message is increased, the display of list items of electronic contents will be affected. Therefore, as shown in FIG. 9, an item 911 is configure to switch to the previous message, and an item 912 is configured to switch to the next message. After switching, messages of different applications can be displayed, or only messages of the same application can be displayed.

After the message switching operation interface is configured in the list items, multiple messages can be placed into one list item, which reduces the impact on other list items of electronic contents.

In embodiment 11, the target application can acquire multiple types of messages, including instant communication messages, Email messages and SMS messages, so a composite message list interface can be added in the target application in the embodiment. The list in the composite message list interface does not display list items of electronic contents such as news, but only displays list items of various types of messages.

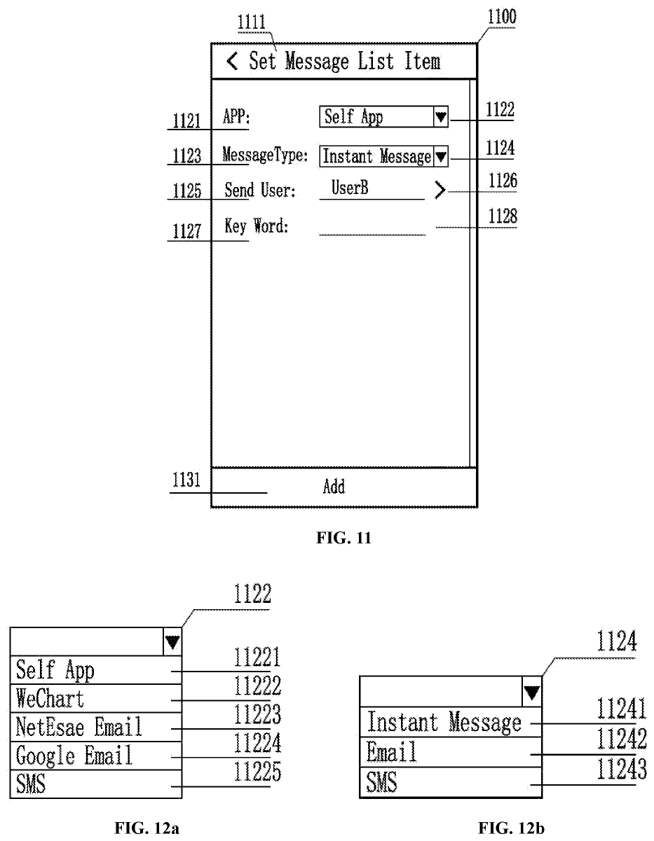

For example, items 520 and 1010-1040 shown in FIG. 10 are list items of messages, and message markings in the message marking area at the top are: “Message” (representing an instant message of the application), “Wechart”, “Google Email”, “NetEasy Email” and “SMS”. In prior art, the user may need to open five application interfaces to view these messages. With the composite message list interface as the aggregation center of various messages, the user only need to open the target application, which is simple and convenient.

In embodiment 12, list items of messages conforming to the set display conditions can be added and displayed only in the electronic content list in the above step S202. In view of this, the method can also comprise the step of acquiring the message display conditions set by the user so as to screen out messages conforming to the display conditions for display in step S202 rather than to display list items of each message acquired in step S201 through the electronic content list.

The display conditions can include at least one of the type, source, send user and keywords of a message to be displayed.

For example, the interface in FIG. 10 shows that multiple types of messages can be received. But a lot of different types of messages exist, and a lot of spam messages may exist, so it is necessary to screen out useful or important messages. The interface 1100 shown in FIG. 11 is a set interface of the target application, and a title item 1111 is “Set Message List Item”, which is used for setting messages that can be displayed in the electronic list.

“APP” (application) of an item 1121 in the figure represents a source application of a message, for example, all options can be displayed by clicking on the drop-down selection box 1122 on the right, as shown in FIG. 12a, wherein items 11221-11225 respectively correspond to “Self App”, “Wechart”, “NetEasy Email”, “Google Email” and “SMS”. The local user can select the item 11221 “Self App” (this application), which is displayed in the item 1122 in FIG. 11.

The item 1123 “MessageType” in FIG. 11 represent the type of a message, i.e., the type of a message that can be received in the application selected in the item 1122. For example, after click on the item 1124 of a drop-down selection box on the right, all options shown in FIG. 12b will appear, wherein items 11241, 11242 and 11243 respectively display “Instant Messages”, “Email” and “SMS”. The local user clicks on “Instant Messages” of the item 11241, which are displayed in the item 1124 in FIG. 11.

If the user respectively selects “NetEasy Email” or “SMS” from the item 1122, since the application can only receive one type of application, the item 1124 in FIG. 11 directly display “Email” or “SMS” respectively, which cannot be selected. The item 1125 “Send User” in FIG. 11 represents the send user selected to send messages in the application selected in the item 1122. After the user clicks on the item 1126 on the right, the target application can call the user list interface of the application selected in the item 1122 to receive one or more users selected by the local user and then return and display the use in the item 1126, for example, UserB.

The item 1127 “Key Word” in FIG. 11 indicates that the word entered in the item 1128 on the right is keyword in the message. Only messages that match the settings of the items 1122, 1124 and 1126 and contain the keyword can be inserted into the electronic content list. If no keyword is set, all messages that match the above settings can be displayed. For example, the item 1128 in FIG. 11 is blank, indicating that all messages sent by the user UserB to the local user can be inserted as list items into the electronic content list.

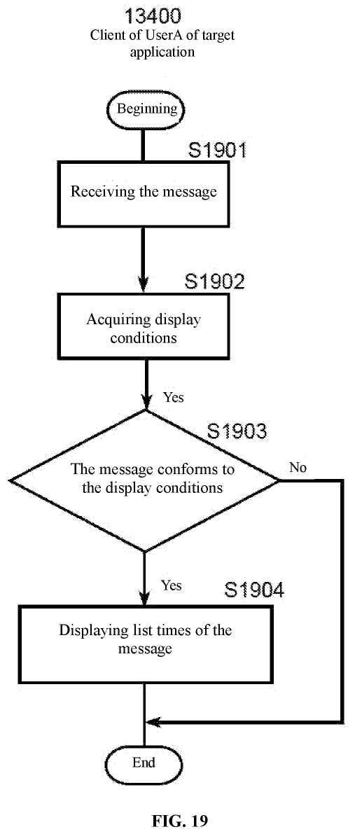

After all the above items are set, the client of the target application can store the set conditions in the terminal device where the client is located by clicking on the item 1131 “Add” button in FIG. 11 or send the set conditions to the application server, and the server will record the set conditions into the database. Then, according to the process in FIG. 19 described in details below, the list items of messages that match the above conditions are displayed in the list interface of the target application.

### Example 1

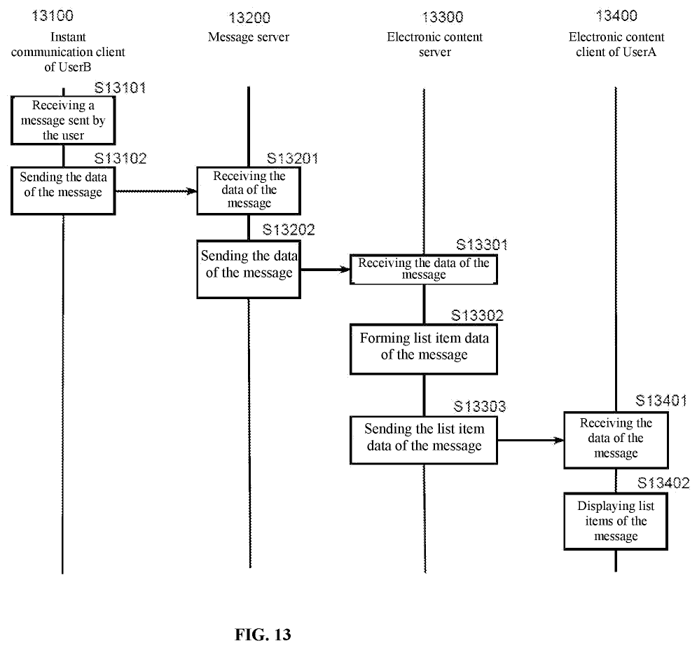

FIG. 13 is a more detailed flow chart of embodiment 1 shown in FIG. 2.

FIG. 13 shows a client (13100) of the instant communication application of the user UserB, a message server 13200, an electronic content server 13300 of the target application, and a client (13400) of the user UserA in the target application, wherein the client 13400 of the user UserA displays the electronic content interface such as the interface shown in FIG. 3 or FIG. 4.

When the client 13100 of the user UserB receives the message (S13101) sent by the user UserB to the user UserA, the data (S13102) of the message is sent to the message server.

After the message server 13200 receives the data (S13201) of the message, the data (S13202) is sent to the electronic content server 13300.

The electronic content server 13300 forms the list item data (S13302) of the message according to the data of the message after receiving the data (S13301) of the message transmitted by the message server 13200, i.e., the data can be displayed in a list item of the electronic content list after being read by the client of the target application. Then, the list item data (S13303) of the message is sent to the client 13400 of the user UserA.

After the client 13400 of the target application of the user UserA receives the list item data (S13401) of the message, the list item can be inserted into the electronic content list to display the message (S13402), as shown in FIG. 5.

In FIG. 13, in step S13202, the user UserB can also send a message to the client 13400 of the target application of UserA directly. When the client 13400 identifies the message as message data, a list item can be inserted into the electronic content list to display the message, as shown in FIG. 5.

The above concrete implementation method of inserting a message list item into a list, for example, in an Android system, can rewrite the getView function in a derived class of an adapter ArrayAdapter corresponding to a list control ListView. Inside the function, when a new message is judged to be received and the list item transmitted is the specified list item, the layout of the message list item is loaded and the data of the message is set. In this way, when an electronic content list is drawn, the getView function is called to display the message in the specified list item.

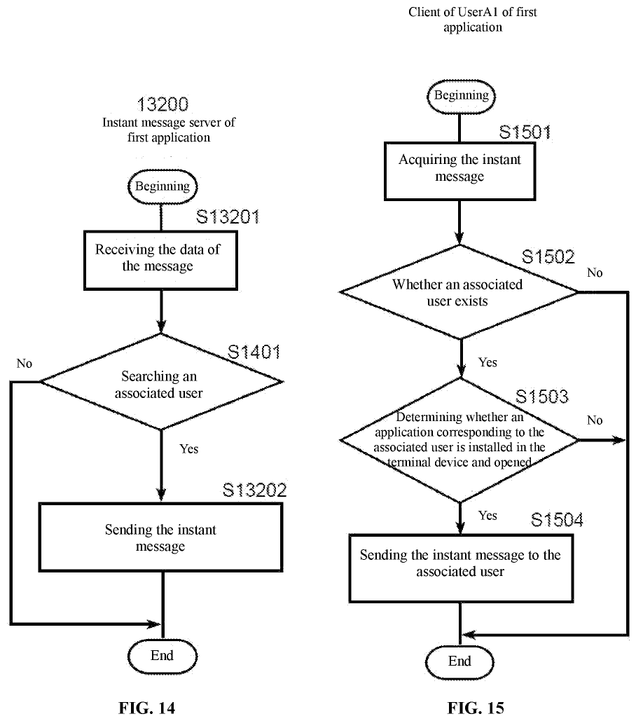

In FIG. 13, the client 13100 of the user UserB and the message server 13200 can belong to the target application or other applications such as the first application. Referring to FIG. 14, the instant message server 13200 of the first application searches the database of the user UserA1 for an associated user (S1401) after receiving the message (S13201) transmitted to UserA1 by a client such as UserB. If not, no processing is performed. If the user UserA1 is found to have an associated user UserA in the target application, the message is transmitted to the electronic content server (S13202) of the target application, and then the message is transmitted to the target application and displayed according to the process after step S13202 in FIG. 13.

In addition to the above method, the target application can also acquire an instant message from the client of the first application. Referring to FIG. 15, after acquiring an instant message (S1501) transmitted from the server thereof, the client of the user UserA1 of the first application installed on the terminal device of the local user will check whether an associated user (S1502) exists, for example, inquiring whether the client of the user UserA1 saves the associated user thereof, or send a request to the server of the first application to inquire whether the database of the receiving user UserA1 has an associated user.

If the check result is no, the current operation is ended; If the associated user UserA of the target application is found, the client of the first application will check whether the terminal device is provided with the target application and the target application is in the state capable of receiving messages, for example, in the state of being opened (S1503).

If the check result is no, the current operation is ended; and if the check result is yes, the first application sends the identifier thereof and a newly received instant message to the target application (S1504). In this way, the target application acquire an instant message from the first application.

For the above step S1504, for example, in a client with an Android system, the following prior art can be adopted:

The first application creates a Service object in the backstage to listen for messages coming from the network

When a message is received, the first application creates an Intent object, and attaches message data of the sender;

The first application broadcasts the Intent object through sendBroadcast or sendOrderedBroadcast;

The target application creates and registers a broadcast reception object with the type of BroadcastReceiver;

After receiving the broadcast sent by the first application, the broadcast reception object of the target application sends the message to an active object corresponding to the electronic content list in the onReceive function to add list items of the message.

In another embodiment, the target application can also obtain instant messages from the client of the first application in a specific way of not using the broadcast of the first application, and the first application uses the Intent object to start a Service of the target application to transmit the message and then display the list items of the message.

Further, list items of an Email can be added in addition to adding and displaying list items of instant communication messages. When sending an Email or an instant message, the user shall designate the receiver. Therefore, in the flow chart of FIG. 13, the client 13100 and the server 13200 can be a client and a server both having the Email function, and can belong to the target application or other applications such as NetEasy Mail Master. Therefore, the process shown in FIG. 13, FIG. 14 or FIG. 15 can be implemented. Finally, a list item 1030 with the title of “Neteasy Email” is added in FIG. 10, wherein, an item 1031 represents the mailbox of the sender.

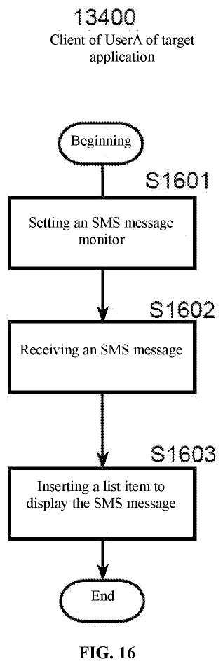

Further, list items of an SMS message can be added and displayed in addition to adding and displaying list items of instant communication messages. Referring to FIG. 16, the following method can be adopted. An SMS reception monitor (S1601) is set in the client of the target application to monitor SMS messages received by the terminal device where the client is located, which belongs to the prior art. When monitoring that the terminal device receives an SMS message (S1602), the monitor issues an instruction to add a list item to the electronic content list of the client so as to display the content of the SMS message (S1603).

Finally, the SMS message is shown in the list item 1040 with the title of “SMS” in FIG. 10, wherein an item 1041 is the send number of the SMS message.

With the above method of the present disclosure, the user will not miss out various types of messages when reading electronic contents.

### Example 2

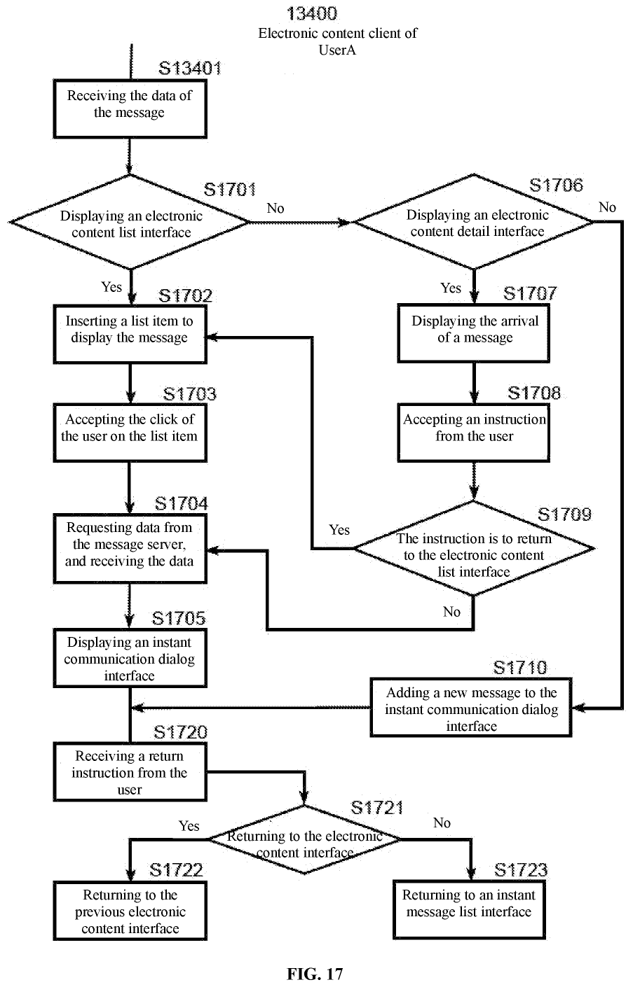

FIG. 17 and FIG. 18 illustrate the processing flow of the client after receiving the message with an instant communication message as an example. The flow is also applicable to messages such as Email and SMS. In FIG. 17, the electronic content client 13400 of the user UserA first judges whether the electronic content list interface is being displayed (S1701) after performing step S13401 in FIG. 13. It yes, for example, when FIG. 3 is displayed, list items of an instant message are inserted on the list interface to display the message (S1702), for example, list items 510 and 520 in FIG. 5.

When receiving the click of the local user on the list items of the instant message (S1703), the client 13400 makes a request to the message server 13200 to obtain more data of message dialog with the user UserB and receive the data of dialog (S1704). If the message is detected as coming from the first application in this step, the client 13400 of the target application sends a notification to the client of the first application of the same terminal device to let the client of the first application send the request to the server of the first application. When obtaining the data of the message dialog, the client of the target application or the first application displays an instant communication dialog interface with the user UserB (S1705), as shown in FIG. 6, wherein the instant message returned by the request includes the message of the item 621. The above steps S1703-S1705 corresponding to embodiment 2.

When a negative result is returned in step S1701, the client 13400 judges whether the electronic content detail interface is being displayed (S1706). If yes, for example, when the interface in FIG. 4 is displayed, the arrival of a message is displayed (S1707), for example, items 731 and 732 in FIG. 7. If the user operates on this interface, the instruction of the user is accepted (S1708). Whether the instruction is to return to the electronic content list interface (S1709) is judged. If yes, for example, if the user clicks on the item 411 in FIG. 7, step S1702 is performed, and the interface shown in FIG. 5 is displayed; and if not, for example, if the user clicks on the item 731 in FIG. 7, steps S1704 and S1705 are performed, and the instant communication dialog interface is displayed, as shown in FIG. 6. During this process, steps S1706 and S1707 correspond to embodiment 5, and steps S1708, S1709, S1704 and S1705 corresponding to embodiment 6.

If a negative result is returned in step S1706, it is possible that the client of the target application is displaying the instant communication dialog interface, and at this time, a new message is added on the dialog interface (S1710), for example, the message of the item 622 in FIG. 6.

The return instruction of the user can be received on the instant communication dialog interface displayed in step S1705 or S1710 (S1720), as shown in FIG. 6. Whether the instruction is to return to the electronic content interface (S1721) is judged. If yes, for example, the user can click on the item 613 in FIG. 6 to return to the electronic content interface before entering the instant communication dialog interface (S1722), for example, FIG. 5 or FIG. 7. In the case of a negative result, the user can click on the item 611 in FIG. 6 to return to the instant message list interface (S1723), as shown in FIG. 8. Steps S1720, S1721 and S1722 in this process correspond to embodiment 8.

In another embodiment, the user can also return to the interface in FIG. 0.3 or FIG. 4 through step S1722. On the electronic content list interface 300 shown in FIG. 5, if the user respectively clicks on the list items 510 and 520 of an instant message and then returns to the interface 300, at this time, in step S1722, the new instance messages are all viewed, so the list items are no longer displayed, and the user returns to the interface shown in FIG. 3 again.

Similarly, on the electronic content detail interface 400 shown in FIG. 7, if the user clicks on the item 731 twice and then returns to the detail interface 400, at this time, in step S1722, the new instance messages are all viewed, so the markings are no longer displayed, and finally, the user returns to the interface shown in FIG. 4 again.

### Example 3

FIG. 18 shows an alternative processing flow for the target application to click on the list items of the instant message for the local user in the example that the instance message contains sharing contents. The example shows a more detail implementation step for embodiments 3 and 4.

In FIG. 18, the client of the target application of UserA checks whether the instant message contain the shared contents (S1801) after receiving the operation performed by the user by clicking on the list items of the message (S1703). If not, step S1704 and the subsequent steps in FIG. 17 are performed. If the instant message contains the shared contents, whether the share contents contain a website is checked (S1802). If yes, the website is opened to display and the corresponding webpage (S1803). For example, the user clicks on the list item 520 in FIG. 5. The list item contains the shared website, so this step is performed. If the share contents do not contain a website, whether the shared contents contain the content identification data of the target application is checked (S1804).

In step S1804, if a positive result is obtained, a request is sent to the electronic content server of the target application to display the shared contents (S1805). A negative result indicates that the shared contents contain content identifiers in another application, so whether the terminal device is provided with the application (S1806) is checked.

In step S1086, if a positive result is obtained, the application is opened, and the identification data of the shared contents is transmitted to request the shared contents (S1808). If a negative result is obtained, another application is installed locally (S1807), and then step S1808 is performed.

In embodiment 12, the target application receives and stores the message conditions set by the user through the interface in FIG. 11. Then referring to FIG. 19, the client of the target application receives a message (S1901). The message can be provided by the server of the target application, or the server of another application such as Wechart, Email and SMS through the server of the target application, or the client of another application installed in the terminal device where the target application is located. Then, the display conditions of the message set by the user through FIG. 11 are acquired (S1902). The display conditions can be read from the terminal device where the client is located or the server according to the storing position. Then, whether the message conforms to the display conditions of the message is judged (S1903). If yes, the list items, such as items 520 and 1010-1040 in FIG. 5, of the message are displayed in the electronic content list (S1904), or prompts, such as items 731 and 732 in FIG. 7, are added to the electronic content detail interface. Finally, the current operation is ended. If a negative result is returned in step S1903, the list items of the message or prompts are not displayed.

For example, if an SMS message, including a “credit card bill”, is received from a bank in step S1901, in step S1902, the display conditions are acquired. In step S1903, through comparison, the message conforms to one of the display conditions, and a positive comparison result is obtained. Therefore, in step S1904, the list items of the message, such as list items of the SMS message shown in the item 1040 in FIG. 10, are added to the electronic content list.

The message to be displayed can be screened on the server of the target application, or on the terminal device installed in the target application, or in the first application. For example, if the client of the target application receives messages from the server of the target application, and the display conditions are stored in the server of the target application, so screening can be directly performed in the server of the target application, and only the qualified messages are sent to the client of the target application and displayed in the electronic content list.

### Example 4

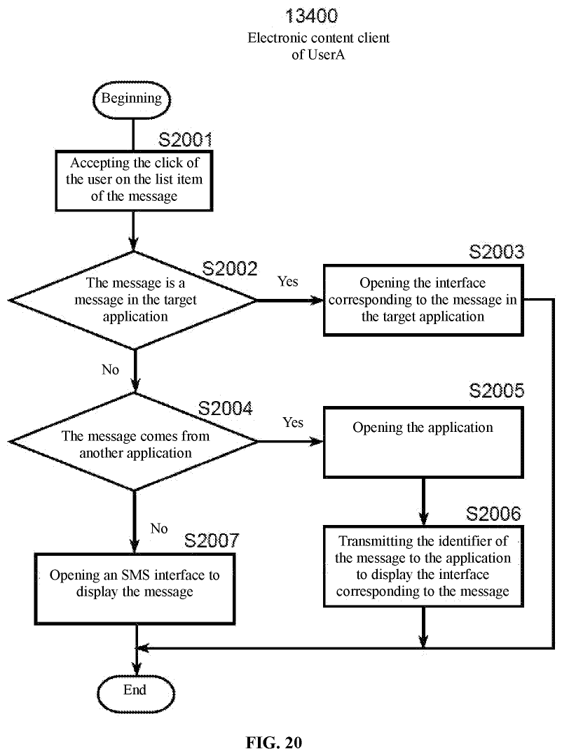

In embodiment 11, the interface in FIG. 10 shows various list items. The flow chart in FIG. 20 shows the steps implemented by the user when clicking on the list items in FIG. 10. After beginning, the click of the user on the list items of the message is accepted first (S2001). Then whether the message is a message in the target application (S2002) is judged. If a positive result is obtained, the interface corresponding to the message in the target application (S2003) is opened, and then the current operation is ended. If a negative result is obtained, whether the message comes from another application (S2004) such as Wechart and NetEasy Email is judged. If a positive result is obtained, the application is opened (S2005), and the identification of the message is transmitted to the application to display the interface corresponding to the message (S2006), and then the current operation is ended. If a negative result is returned in step S2004, the SMS interface is opened to display the SMS message (S2007), and then the current operation is ended.

In step S2005, for example, for an Android in the client, if another application, such as the first application, is an instant communication application, the following steps can be performed:

The target application creates a ComponentName object, and transmits the package title of the first application and the activity title displaying the dialog interface in the first application;

The target application creates an Intent object and adds, for example, the data of the ComponentName object and the sender of the message.

The target application calls startActivity with the Intent object to start, for example, the dialog interface of the first application.

The first application acquires the data of the sender of the message from the Intent object;

The first application displays a dialog interface with the sender.

On the interface shown in FIG. 10, if the user clicks on list items 520, 1010, 1020, 1030 and 1040 in sequence, the display webpage, the instant communication dialog interface, the Email interface of Google Email, the email interface of NetEasy Email and the SMS interface can be respectively opened according to the flow shown in FIG. 20.

### Device Embodiment

In one embodiment, a terminal device shown as 110 in FIG. 1 is provided, comprising a memory and a processor, wherein the memory is used for storing executable instructions; and the processor is used for executing the instructions to implement the method of the present disclosure.

### Server Embodiment

In one embodiment, a server device is also provided, comprising a processor and a memory, wherein the processor is used for loading and executing instructions stored in the memory to implement the method of the present disclosure, comprising:

1. Based on the receiver of the message, searching an associated user thereof in the target application.

2. Sending the associated user to the client, wherein the client sends the message to the client of the target application of the associated user, and the client of the target application adds a list item displaying the message to the electronic content list; or

3. Sending the message to the server of the target application, wherein the server of the target application sends the message to the client of the target application, and the client of the target application adds a list item displaying the message to the electronic content list.

In one embodiment, a server device is also provided, comprising a memory, wherein the memory is used for storing computer program instructions for implementing the method according to any embodiment of the present disclosure for downloading.

For example, the server device provides executable files of a target application for downloading. The executable files of the target application can be downloaded from the server device at any terminal device through the network 1800 shown in FIG. 1. After the target application is installed, the terminal device can implement the data processing method according to any embodiment of the present disclosure.

### Medium Embodiment

In one embodiment, a computer readable storage medium is also provided. The medium stores computer program instructions that can be read and executed by the computer, and the computer program instructions are used for implementing the method of the present disclosure when being read and run by the computer.

The computer programs described herein can be downloaded from the computer readable storage medium to various computing/processing devices or downloaded to external computers or external storage devices over the network such as Internet, local area network, wide area network and/or wireless network. The computer programs used for performing the operation of the present disclosure may be source codes or object codes written in any one or more programming languages.

Various aspects of the present disclosure are described according to the flow charts and/or block diagrams of the method, device, storage medium and computer program product of the embodiments of the present disclosure. It should be understood that each block of the flow charts and/or block diagrams and the combination of the blocks of the flow charts and/or block diagrams can be implemented by computer readable program instructions.

The embodiments of the present disclosure have been described above. The above embodiments are exemplary but not exhaustive, and not for limiting the embodiments disclosed herein. Many modifications and changes are apparent to those skilled in the art without departing from the scope and spirit of the embodiments described in the present disclosure. The terms used herein are selected to best explain the principle and practical application of each embodiment, to improve the technology in the market, or to enable others skilled in the art to understand each embodiment disclosed herein. The scope of the present disclosure is defined by the appended claims.

1: A data processing method, comprising:
acquiring messages;
adding and displaying list items of the messages in an electronic content list.

2: The method of claim 1, wherein the step of adding and displaying list items of the messages in an electronic content list comprises: adding and displaying list items of the messages in the current display area of the list.

3: The method of claim 2, wherein the list items of the messages are displayed in a notable mode different from the list items of electronic contents.

4: The method of claim 1, wherein the messages comprise at least one type of instant communication messages, email messages and SMS messages.

5: The method of claim 1, wherein the messages comprise messages from other applications.

6: The method of claim 1, further comprising:
acquiring the display conditions of the messages set by a user;
adding and displaying list items of the messages meeting the display conditions in the electronic content list.

7: The method of claim 1, further comprising:
providing a composite message list, wherein the composite message list comprises list items of various types of messages.

8: The method of claim 2, further comprising:
opening an interface corresponding to the messages in response to the operation of opening the list items of the messages.

9: the method of claim 7, further comprising:
opening an interface corresponding to the messages in response to the operation of opening the list items of the composite message list.

10: The method of claim 1, wherein the messages comprise instant messages, and the method further comprises:
displaying shared contents in the case that the instant messages contain the shared contents in response to the operation of opening the list items of the instant messages.

11: The method of claim 10, wherein the step of displaying shared contents comprises: loading the shared contents of the identifier of the shared contents, comprising:
in the case that the identifier is a website, opening the website to display the corresponding shared contents; and/or,
in the case that the identifier contains an application identifier, requesting the corresponding application to display the shared contents.

12: The method of claim 1, further comprising:
displaying a prompt for the arrival of a new message on an electronic content detail interface.

13: The method of claim 12, further comprising:
opening an interface corresponding to the messages in response to an instruction triggered on the detail interface for viewing the messages.

14: The method of claim 1, wherein the messages comprise instant messages, and the method further comprises:
opening an instant message interface corresponding to the instant messages in response to the operation of opening the list items of the instant messages on the interface of the electronic content list or in response to an instruction triggered on the detail interface for viewing the instant messages on the electronic content detail interface;
configuring an operation interface for triggering return instructions on the instant communication dialog interface;
returning to an electronic content interface before entering the instant communication dialog interface in response to a return instruction triggered through the operation interface.

15: The method of claim 1, further comprising:
displaying an operation interface for replying to messages in the list items of the messages; or,
configuring an operation interface for switching messages in the list items of the messages.

16: A terminal device, comprising:
a memory, used for storing executable instructions;
a processor, used for executing the instructions to implement the method of claim 1.

17: A computer readable storage medium, storing computer program instructions, wherein the computer program instructions are used for implementing the method of claim 1 when being read and run by the computer.

18. (canceled)
